(19) United States
(12) Patent Application Publication
(10) Pub. No.: US 2024/0152803 A1
(43) Pub. Date: May 9, 2024

(54) INFORMATION PROCESSING METHOD AND INFORMATION PROCESSING DEVICE

(71) Applicant: Fujitsu Limited, Kawasaki-shi (JP)

(72) Inventor: Akira URA, Yokohama (JP)

(73) Assignee: Fujitsu Limited, Kawasaki-shi (JP)

(21) Appl. No.: 18/238,531

(22) Filed: Aug. 28, 2023

(30) Foreign Application Priority Data
Nov. 4, 2022 (JP) 2022-177603

(51) Int. Cl. G06N 20/00

(52) U.S. Cl. CPC G06N 20/00

(57) ABSTRACT

A non-transitory computer-readable recording medium stores a program for causing a computer to execute a process, the process include identifying frequency components stronger than a predetermined reference among frequency components of time-series data, calculating values that indicate a relationship between one or more parameters used when generating a plurality of time-series features of the time-series data and periods having the identified frequency components, as features for the parameters, executing training of a first machine learning model by using importance of each of the time-series features on prediction that uses the time-series features and the features for each of the parameters to predict the importance of the time-series features from the features for each of the parameters, the time-series features being generated based on the parameters, and predicting importance of time-series features for new time-series data by using the trained first machine learning model.

### CROSS-REFERENCE TO RELATED APPLICATION

This application is based upon and claims the benefit of priority of the prior Japanese Patent Application No. 2022-177603, filed on Nov. 4, 2022, the entire contents of which are incorporated herein by reference.

### FIELD

The embodiments discussed herein are related to an information processing method and an information processing device.

### BACKGROUND

The technique that automates some of diverse tasks included in analysis using machine learning is called automated machine learning (AutoML). In the automated machine learning, processes such as optimization of a setting value of a hyperparameter for an algorithm of machine learning and selection of an algorithm that gives the most precise result are automated.

Such automated machine learning has been used in many fields, but automated machine learning for time-series data may be said to be at the stage where sufficient studies have not been made yet. The time-series data mentioned here refers to data including time information at which the data is acquired. For example, the access log of a user including the time is time-series data. In contrast to this, the user data including the birthday is not the time-series data because the birthday is the time but is not the time information at which the data is acquired.

The reasons why the automated machine learning for the time-series data does not proceed include reasons as follows. In machine learning using time-series data, it is often expected to generate time-series features such that appropriate analysis is allowed to be performed. The time-series feature is a feature characterizing the time-series data and is a feature using information on a time before the time corresponding to the time-series data.

When such a time-series feature is automatically generated, there are an enormous number of candidates for the time-series feature, and thus it is difficult to generate all the candidates for the time-series feature from the viewpoint of time and data amount, which is one of the reasons. When the time-series data is used, for example, it may be one of the elements of the time-series feature which time width is to be used, but there are many ways to choose the time width. The time width is, for example, information that determines a time range of time-series data to be grouped, such as one hour, one day, or one week. When the time width to be used is chosen by a human, a promising time width may be deliberately selected in consideration of the meaning of each time range, but in automated machine learning, it is hard to automatically consider such a meaning, and thus all time widths will be evaluated.

Note that, as a technique in the automated machine learning, a technique of calculating the importance of each feature from a meta feature of the feature has been proposed. The meta feature is information expressing what kind of feature a certain feature is. In addition, a technique has been proposed in which time-series data is converted into frequency domain data, a time width to be set in the time-series data is determined from the frequency data, the importance of each time width is calculated from a result of machine learning using the time-series data of the determined time width, and then the time width is selected.

International Publication Pamphlet No. WO 2020/059498 is disclosed as related art.

### SUMMARY

According to an aspect of the embodiments, a non-transitory computer-readable recording medium stores a program for causing a computer to execute a process, the process include identifying frequency components stronger than a predetermined reference among frequency components of time-series data, calculating values that indicate a relationship between one or more parameters used when generating a plurality of time-series features of the time-series data and periods having the identified frequency components, as features for the parameters, executing training of a first machine learning model by using importance of each of the time-series features on prediction that uses the time-series features and the features for each of the parameters to predict the importance of the time-series features from the features for each of the parameters, the time-series features being generated based on the parameters, and predicting importance of time-series features for new time-series data by using the trained first machine learning model.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram of an information processing device according to a first embodiment;

FIG. 2 is a diagram illustrating data used by the information processing device;

FIG. 3 is a block diagram of a meta-machine learning processing unit;

FIG. 4 is a diagram illustrating combinations of elements for each piece of time-series data and correspondences between time-series features and objective variables;

FIG. 5 is a diagram illustrating an example of time-series data on which Fourier transform is performed;

FIG. 6 is a diagram illustrating meta-machine learning according to the first embodiment;

FIG. 7 is a block diagram of a machine learning processing unit;

FIG. 8 is a diagram illustrating calculation of the importance of a combination of elements according to the first embodiment;

FIG. 9 is a flowchart illustrating an outline of a prediction process for time-series data using machine learning by the information processing device according to the first embodiment;

FIG. 10 is a flowchart of a meta-machine learning process by the information processing device according to the first embodiment;

FIG. 11 is a flowchart of a machine learning process by the information processing device according to the first embodiment;

FIG. 12 is a diagram illustrating calculation of the importance of each time width;

FIG. 13 is a diagram illustrating meta-machine learning according to a second embodiment;

FIG. 14 is a diagram illustrating calculation of the importance of a combination of elements according to the second embodiment;

FIG. 15 is a flowchart of a meta-machine learning process by an information processing device according to the second embodiment;

FIG. 16 is a flowchart of a machine learning process by the information processing device according to the second embodiment;

FIG. 17 is a diagram illustrating an example of time-series data in a first modification;

FIG. 18 is a diagram illustrating an example of time-series data in a second modification; and

FIG. 19 is a hardware configuration diagram of the information processing device.

### DESCRIPTION OF EMBODIMENTS

Even if the technique of determining the importance of each feature using the meta feature is used, the meta feature is not obvious with respect to the time-series feature generated from the time width or the like. Therefore, even if the meta feature is simply used, it is hard to evaluate the importance of the time-series feature, and it is difficult to appropriately select the time-series feature. For example, a case will be considered in which, as the meta feature of the time-series feature, a combination of the time width, a shift width that corresponds to an amount of shift of range data obtained by grouping the time-series data included in the time width to the next range data, the number of uses of the range data, and a function for calculating the time-series feature is used. When such a meta feature is used, it is difficult to find the importance of each piece of the time-series data each having a meta feature, for example, for the reason that the content expressed by the meta feature changes with respect to the scaling on the time axis. In addition, in the technique of determining the time width to be set in the time-series data from the frequency data, it is difficult to evaluate the importance of each temporal feature, and it is difficult to appropriately select the time-series feature. Accordingly, in the existing automated machine learning techniques, it has been difficult to improve the efficiency of machine learning using time-series data.

Hereinafter, embodiments of an information processing method and an information processing device disclosed in the present application will be described in detail with reference to the drawings. Note that the following embodiments do not limit the information processing method and the information processing device disclosed in the present application.

### First Embodiment

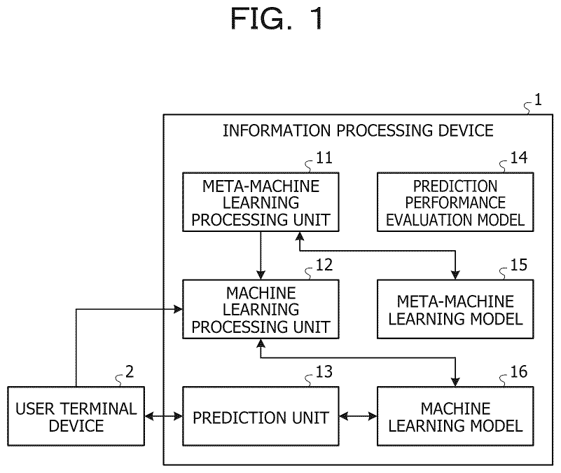

FIG. 1 is a block diagram of an information processing device according to a first embodiment. An information processing device 1 according to the first embodiment is coupled to a user terminal device 2 through a network. As illustrated in FIG. 1, the information processing device 1 includes a meta-machine learning processing unit 11, a machine learning processing unit 12, a prediction unit 13, a prediction performance evaluation model 14, a meta-machine learning model 15, and a machine learning model 16.

The information processing device 1 according to the first embodiment executes training of the meta-machine learning model 15 that finds the importance of each time-series feature using each meta feature for a plurality of time-series features of time-series data. Next, the information processing device 1 uses the meta features of the time-series features of new time-series data for the trained meta-machine learning model 15 to calculate the importance of each time-series feature and uses the calculated importance to determine the time-series features used when prediction based on the new time-series data is performed. Then, the information processing device 1 trains the machine learning model 16, using the determined time-series features of the new time-series data. Thereafter, the information processing device 1 inputs the prediction target time-series data to the trained machine learning model 16 and executes specific prediction.

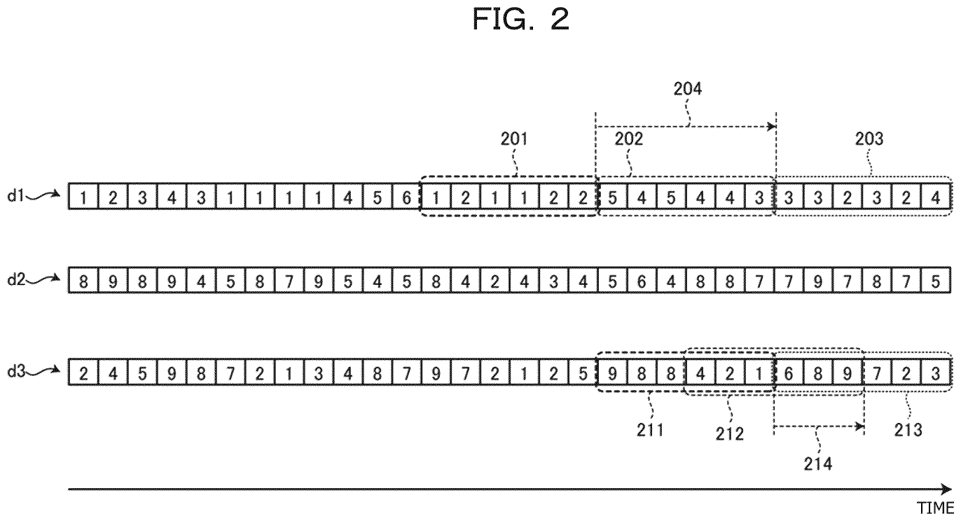

FIG. 2 is a diagram illustrating data used by the information processing device. Here, various types of data used by the information processing device 1 will be described with reference to FIG. 2.

The information processing device 1 uses, for example, time-series data d1 to d3. The time-series data d1 to d3 are time-series data that may be regarded as data with fixed acquisition time intervals. For example, the time-series data d1 to d3 are sets of individual pieces of data obtained at fixed time intervals. In the time-series data d1 to d3 illustrated in FIG. 2, a plurality of squares are illustrated as being arranged in a line, where this one square corresponds to one individual piece of data. In the time-series data d1 to d3, individual pieces of data are arranged as time elapses. Furthermore, in FIG. 2, a number written inside the square of each of the individual pieces of data represents the value of each of the individual pieces of data. Since the individual pieces of data is acquired at fixed intervals, the time lapse is represented by the number of consecutive individual pieces of data in the time-series data d1 to d3. When the number of consecutive individual pieces of data is the same, it may be said that the individual pieces of data are acquired with the same time width. In the following description, time will be represented by the number of the individual pieces of data. For example, time represented by n individual pieces of data is called n.

In addition, in the first embodiment, a concept of a combination of elements that determines the time-series features that are the features of the time-series data d1 to d3 is used. The combination of elements includes, for example, elements of a “time width” that determines the size of one piece of range data, a “shift width” that is an interval between pieces of range data, and a “number of pieces of data” that is the number of pieces of range data used for calculation of the feature.

For example, range data 201 to 203 may be used as an example of a combination of elements in the time-series data d1. Each time lapse in the range data 201 to 203 is a time width, and each time width of the combination of elements represented by the range data 201 to 203 is six. In addition, a time lapse 204 from the individual piece of data having the latest time of the range data 201 to the individual piece of data having the latest time of the range data 202 is a shift width, and the shift width of the combination of elements represented by the range data 201 to 203 is six, which coincides with the time width. Furthermore, since the number of pieces of range data 201 to 203 is three, the number of pieces of data of the combination of elements represented by the range data 201 to 203 is three.

The time width, the shift width, and the number of pieces of data included in the combination of elements are freely determined. In addition, the time width and the shift width may be different. In the combination of elements represented by range data 211 to 213 illustrated in the time-series data d3 in FIG. 2, the time width is six, the shift width represented by a time lapse 214 is three, and the number of pieces of data is three. Besides, for example, the time width may be four, and the number of pieces of data may be ten. In addition, it may also be assumed that the time width is the number of all pieces of data of the time-series data, and the number of pieces of data is one.

Here, the number of pieces of data may be defined as the number of pieces of range data at times after a certain time point, instead of directly determining a numerical value. In addition, other information may also be used as an element included in the combination of elements. For example, “the earliest time of the most recent range data” or the like may also be used as an element, but since the most recent range data is usually set to include the newest data, “the earliest time of the most recent range data” will not be included in the elements here.

Furthermore, in the first embodiment, the time-series feature is calculated using a predetermined function on the range data defined by the time width, the shift width, and the number of pieces of data. The function may be a function of any kind. For example, the function may be a simple function such as a max function that acquires a maximum value, a min function that acquires a minimum value, a mean function that calculates a mean value, or a stddev function that calculates a standard deviation, or a function that performs Fourier transform, or the like may be used.

For example, in the first embodiment, the time-series feature is calculated by a combination of the time width, the shift width, the number of pieces of data, and the function. Accordingly, the combination of elements for generating the time-series feature according to the first embodiment has the time width, the shift width, the number of pieces of data, and the function as elements.

Returning to FIG. 1, the description will be continued. The prediction performance evaluation model 14 is a machine learning model that performs prediction using a plurality of time-series features for time-series data. The prediction performance evaluation model 14 receives an input of the time-series features and outputs a prediction result. For example, when the time-series data is daily sales data and the prediction target is tomorrow's sales prediction, the prediction performance evaluation model 14 receives an input of the sales data and predicts and outputs the tomorrow's sales.

The meta-machine learning model 15 is a machine learning model that performs prediction using the meta feature and predicts the importance of the time-series feature having the input meta feature as a prediction result. For example, for a time-series feature having a combination of elements of predetermined time width, shift width, number of pieces of data, and function, the meta-machine learning model 15 performs prediction using the meta feature obtained from the time width as an element of that time-series feature and outputs the importance of that time-series feature. This meta-machine learning model 15 corresponds to an example of a “first machine learning model”.

The machine learning model 16 is a machine learning model that performs prediction with the time-series feature selected by the machine learning processing unit 12 for the time-series data as an input. The machine learning model 16 receives an input of the time-series data and outputs a prediction result of specific prediction. For example, when the time-series data is daily sales data and the prediction target is tomorrow's sales prediction, the machine learning model 16 receives an input of the sales data and predicts and outputs the tomorrow's sales using the time-series feature according to the input time-series data. Note that the prediction using the machine learning model 16 exemplified here is an example. For example, a machine learning model that predicts a value or a transition of future time-series data with time-series data as input data, or a machine learning model that predicts the presence or absence of anomaly or the like based on time-series data may also be employed as the machine learning model 16. This machine learning model 16 corresponds to an example of a “second machine learning model”.

The meta-machine learning processing unit 11 evaluates the prediction results output from the prediction performance evaluation model 14 with respect to the combinations of elements of the time-series features in the time-series data and finds the importance of each combination of elements of the time-series features. Then, the meta-machine learning processing unit 11 trains the meta-machine learning model 15, using the meta feature of the time-series feature for each combination of elements and the importance of each combination of elements. Details of the meta-machine learning processing unit 11 will be described below.

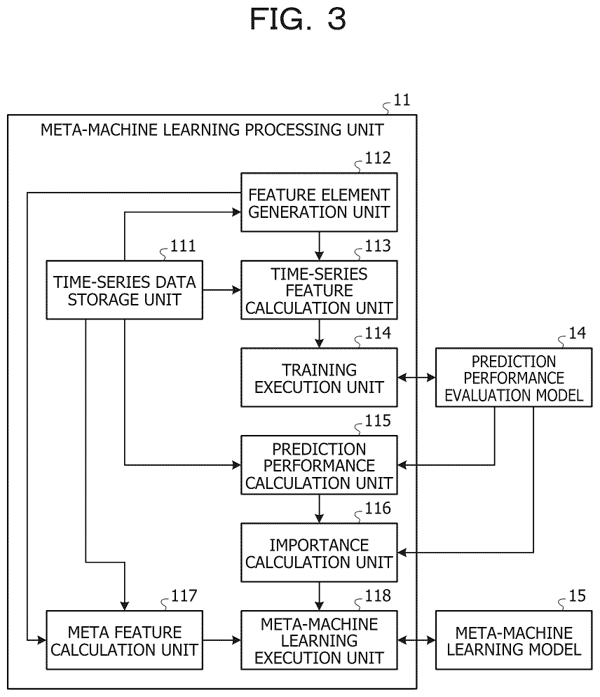

FIG. 3 is a block diagram of a meta-machine learning processing unit. The meta-machine learning processing unit 11 includes a time-series data storage unit 111, a feature element generation unit 112, a time-series feature calculation unit 113, a training execution unit 114, a prediction performance calculation unit 115, an importance calculation unit 116, a meta feature calculation unit 117, and a meta-machine learning execution unit 118.

The time-series data storage unit 111 stores a set of a plurality of pieces of time-series data to be used for training of the meta-machine learning model 15. The time-series data storage unit 111 holds time-series data input in advance by an administrator or the like. In each piece of time-series data, a task setting method is designated in advance.

The feature element generation unit 112 checks the time-series data stored in the time-series data storage unit 111 to determine, according to the time-series data, the time width, the shift width, the number of pieces of data, and the function, which are the elements of the time-series features, and generates a plurality of combinations of elements of the time-series features. In the first embodiment, the feature element generation unit 112 assigns the number of pieces of data among the elements as a constant. Thereafter, the feature element generation unit 112 outputs the generated combinations of elements of the time-series features to the time-series feature calculation unit 113.

For example, the feature element generation unit 112 generates combinations of elements as “time width, shift width, number of pieces of data, function”=“6, 6, 3, max function”, “6, 6, 3, min function”, “4, 4, 3, max function”, “4, 4, 3, min function”, and the like. Here, the feature element generation unit 112 may make the time width and the shift width different. In addition, the feature element generation unit 112 may assign the number of pieces of data as a variable.

The time-series feature calculation unit 113, the training execution unit 114, the prediction performance calculation unit 115, the importance calculation unit 116, and the meta feature calculation unit 117 execute processes to be described below for all the time-series data included in the set of time-series data stored in the time-series data storage unit 111. Here, the processes for time-series data di in the set of time-series data will be described. In addition, here, a set of combinations of elements is assumed as W, and each combination of elements included in W is assumed as wj.

The time-series feature calculation unit 113 receives an input of a combination of elements from the feature element generation unit 112. Next, the time-series feature calculation unit 113 acquires one piece of time-series data di included in the set of time-series data from the time-series data storage unit 111. Then, the time-series feature calculation unit 113 calculates time-series features for each combination wj of elements for the time-series data di. For example, when there are four combinations of elements of the time-series features, the time-series feature calculation unit 113 calculates the time-series features for each of the four combinations of elements for the time-series data di. The time-series feature calculation unit 113 outputs the calculated time-series feature of each combination wj of elements of the time-series data di to the training execution unit 114.

The training execution unit 114 receives an input of the time-series feature for each combination wj of elements of the time-series data di from the time-series feature calculation unit 113. Then, the training execution unit 114 executes training of the prediction performance evaluation model 14 using the acquired time-series features. For example, when predicting the future value using the time-series data, the training execution unit 114 may train the prediction performance evaluation model 14 using the time-series feature of the time-series data up to a predetermined time and the correct answer of the predicted value included in the time-series data for the predetermined time. This generates the trained prediction performance evaluation model 14.

Here, the training execution unit 114 may train the prediction performance evaluation model 14 using a single learner as in logistic regression or random forest, or may search for a plurality of preprocesses or learners to train the prediction performance evaluation model 14 as in the automated machine learning.

The prediction performance calculation unit 115 acquires the time-series data di from the time-series data storage unit 111. Then, the prediction performance calculation unit 115 generates time-series features for each combination wj of elements from the time-series data di and inputs the generated time-series features to the trained prediction performance evaluation model 14 to obtain a prediction result for the time-series data di. Thereafter, the prediction performance calculation unit 115 calculates prediction performance a_{di,0} of the prediction performance evaluation model 14 for the time-series data di, using the acquired prediction results. For example, the prediction performance calculation unit 115 may calculate the prediction performance a_{di,0}, using a determination coefficient (R2).

Here, the prediction performance calculation unit 115 may calculate the prediction performance using the time-series data for use in evaluation in the set of time-series data, or may calculate the prediction performance using the time-series data used for training of the prediction performance evaluation model 14. Thereafter, the prediction performance calculation unit 115 outputs the time-series features, the prediction results, and the prediction performance a_{di,0} for each combination wj of elements for the time-series data di to the importance calculation unit 116.

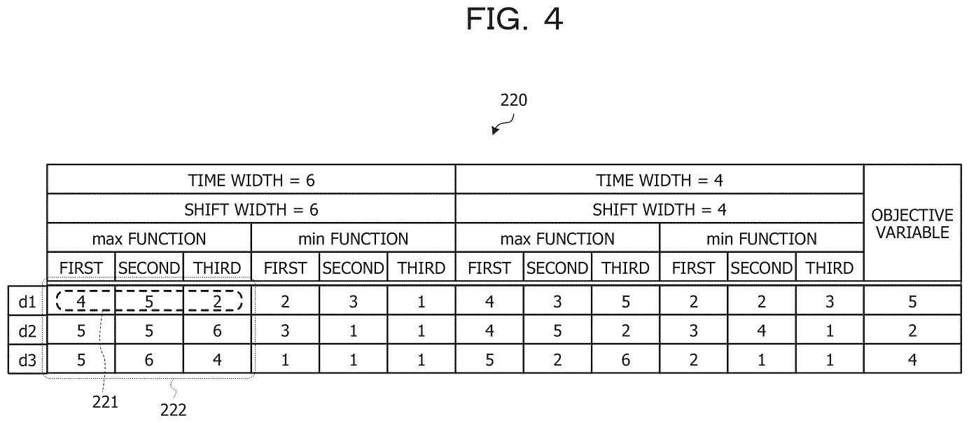

FIG. 4 is a diagram illustrating combinations of elements for each piece of time-series data and correspondences between time-series features and prediction results. FIG. 4 illustrates, as an example, a case where there are four combinations of elements of “6, 6, 3, max function”, “6, 6, 3, min function”, “4, 4, 3, max function”, and “4, 4, 3, min function” for the time-series data d1 to d3.

A table 220 illustrates a correspondence between a time-series feature of each combination of elements in each piece of the time-series data d1 to d3 and an objective variable for the time-series feature. A time-series feature 221 represents a time-series feature of one piece of range data of the time-series data d1 when the combination of elements is “6, 6, 3, max function”. In addition, the objective variable is a value desired to be predicted, and the prediction performance is calculated by comparing the value of the objective variable with the value that has been predicted. For example, the table 220 indicates the time-series features for each of the four combinations of elements and the objective variables for the time-series features in association with each other for each piece of the time-series data d1 to d3. The prediction performance calculation unit 115 calculates the prediction performance for each prediction result for the time-series data d1 to d3.

Returning to FIG. 3, the description will be continued. The importance calculation unit 116 receives inputs of the time-series feature, the prediction result, and the prediction performance a_{di,0} of each combination wj of elements for the time-series data di, from the prediction performance calculation unit 115. Next, the importance calculation unit 116 calculates the importance of each combination wj of elements, using the following evaluation approach, which is called permutation importance, for the contribution of each time-series feature to the feature prediction precision.

For example, the importance calculation unit 116 performs prediction for the combinations wj of elements, using the prediction performance evaluation model 14, by substituting the time-series features for each other between the time-series data di and other time-series data randomly picked, for each combination wj of elements. Then, the importance calculation unit 116 calculates the prediction performance in each case where the substitution is performed.

For example, the importance calculation unit 116 randomly substitutes, for each other, the time-series features in the case of the combination of elements of “6, 6, 3, max function” of each piece of the time-series data d1 to d3 in a group 222 in FIG. 4, for each column, and performs prediction for each piece of time-series data, using the prediction performance evaluation model 14. Similarly, also for combinations of elements such as “6, 6, 3, min function”, “4, 4, 3, max function”, and “4, 4, 3, min function”, the importance calculation unit 116 performs prediction for each piece of time-series data, using the prediction performance evaluation model 14, by randomly substituting the time-series features for each other for each column between the time-series data d1 to d3. Then, the importance calculation unit 116 calculates the prediction performance for each piece of time-series data in each case where random substitution is performed for the combinations of elements such as “6, 6, 3, max function”, “6, 6, 3, min function”, “4, 4, 3, max function”, and “4, 4, 3, min function”.

Next, the importance calculation unit 116 compares the prediction performance a_{di,0} acquired from the prediction performance calculation unit 115 with the prediction performance when respective time-series features are randomly substituted for each other between time-series data for each combination wj of elements. Then, the importance calculation unit 116 calculates importance I_{di,wj} of each combination wj of elements in the time-series data di, based on the comparison results. In one example, the importance calculation unit 116 verifies that a case where the prediction performance is lowered than the prediction performance when the substitution is not performed has higher importance, between a case where the data of a certain combination of elements is substituted for each other and a case where the data of another combination of elements is substituted for each other. The fact that the prediction performance is lowered means that the prediction becomes harder by substituting data for each other.

Thereafter, the importance calculation unit 116 outputs information on the calculated importance I_{di,wj} of each combination wj of elements in the time-series data di to the meta-machine learning execution unit 118.

Here, in the first embodiment, the importance has been found by collectively substituting the whole time-series feature included in the combination of elements for another, but the way of finding the importance is not limited to this. For example, the importance calculation unit 116 may find the importance by substituting every one of the time-series features included in the combination of elements for another and assign a maximum value or a mean value of the found importance, as the importance of the combination of elements.

The meta feature calculation unit 117 acquires the time-series data di from the time-series data storage unit 111. In addition, the meta feature calculation unit 117 receives information on all combinations wj of elements from the feature element generation unit 112.

Next, the meta feature calculation unit 117 performs Fourier transform on the time-series data di. Then, the meta feature calculation unit 117 extracts a predetermined number of periods from the top among the periods having stronger frequency components. For example, the meta feature calculation unit 117 identifies a frequency component stronger than a predetermined reference from among frequency components of the time-series data. In this case, the predetermined reference is the lowest frequency component having the lowest period among the frequency components of the predetermined number of periods from the top.

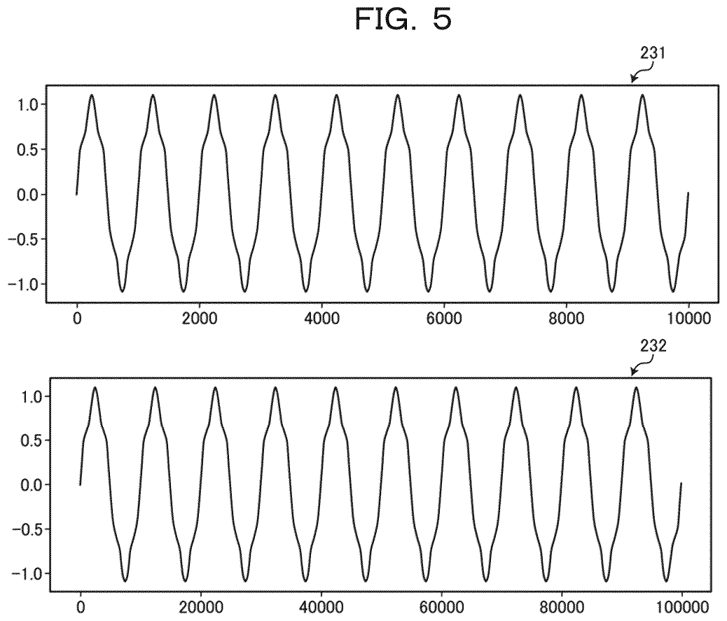

FIG. 5 is a diagram illustrating an example of the time-series data on which Fourier transform is performed. In both of graphs 231 and 232, the horizontal axis represents the time lapse, and the vertical axis represents the value of data. However, the graph 232 is different from the graph 231 in the unit of displaying time on the horizontal axis.

For example, in the graph 231 in FIG. 5, the frequency component of the period 1000 is the strongest, and the frequency component of the period 100 is the second strongest. In the case of the graph 232, the frequency component of the period 10000 is the strongest, and the frequency component of the period 1000 is the second strongest. For example, when extracting two periods, the meta feature calculation unit 117 extracts the periods 1000 and 100 when the result of the Fourier transform is the graph 231 and extracts the periods 10000 and 1000 when the result of the Fourier transform is the graph 232.

Then, the meta feature calculation unit 117 calculates a meta feature f_{di,wj} of the time-series feature for each combination wj of elements in the time-series data di, based on the extracted frequency. In the first embodiment, the meta feature calculation unit 117 calculates information indicating closeness between a constant multiple of the period of data and the time width, as the meta feature f_{di,wj} of the time-series feature for each combination wj of elements.

For example, the meta feature calculation unit 117 assigns, as the meta features f_{di,wj} an integer closest to a value obtained by dividing the time width by each of a predetermined number of periods having stronger frequency components from the top when the Fourier transform is performed on the time-series data di, and a difference between the integer and quotient. Here, the time width in the specific combination wj of elements is assumed as z. Then, a case where the period having the strongest frequency component is assumed as T1 and the period having the second strongest frequency component is assumed as T2 will be considered. In this case, the meta feature calculation unit 117 calculates an integer n1 closest to z/T1. In addition, the meta feature calculation unit 117 calculates an integer n2 closest to z/T2. Then, the meta feature calculation unit 117 assigns n1, |n1−z/T1|, n2, and |n2−z/T2| as the meta features f_{di,wj} of the time-series feature for the specific combination of elements.

Then, the meta feature calculation unit 117 outputs the calculated meta features f_{di,wj} of the time-series features for each combination wj of elements to the meta-machine learning execution unit 118. In this manner, the meta feature calculation unit 117 calculates, as a feature for a parameter (element), a value indicating a relationship between one or more parameters used when a plurality of time-series features of time-series data is generated and the period having the identified frequency component.

The meta-machine learning execution unit 118 receives inputs of all importance I_{di,wj} for each combination wj of elements in the time-series data di from the importance calculation unit 116. The meta-machine learning execution unit 118 also receives inputs of all meta features f_{di,wj} of the time-series features for each combination wj of elements in the time-series data di from the meta feature calculation unit 117.

Then, the meta-machine learning execution unit 118 executes training of the meta-machine learning model 15, using the meta features f_{di,wj} of the time-series features for each combination wj of elements, with all importance I_{di,wj} of each combination wj of elements in the time-series data di as a regression problem. This generates the trained meta-machine learning model 15.

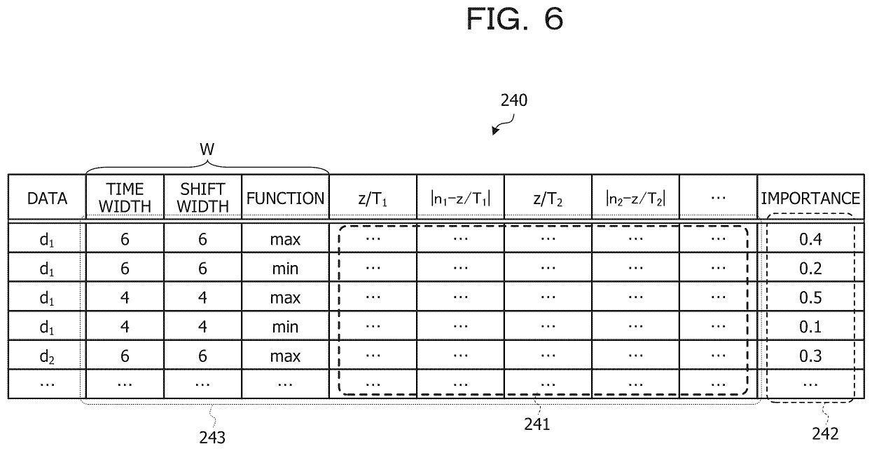

FIG. 6 is a diagram illustrating meta-machine learning according to the first embodiment. Here, there are time-series data d1, d2, . . . . The portion of a column group W in a table 240 indicates each of combinations of elements of the time-series features for each of the time-series data d1, d2, In the first embodiment, since the number of pieces of data is fixed, illustration is omitted. The portion surrounded by a frame 241 indicates the meta features of each combination of elements. The portion surrounded by a frame 242 indicates the importance of each combination of elements. The meta-machine learning execution unit 118 executes training of the meta-machine learning model 15 with data of the portion surrounded by a frame 243 as meta-training data.

The machine learning processing unit 12 acquires the time-series data to be used for training of the machine learning model 16 to determine a combination of elements of the time-series feature suitable for training with the acquired time-series data and executes training of the machine learning model 16, using the time-series feature obtained from the determined combination of elements. Hereinafter, details of the machine learning processing unit 12 will be described.

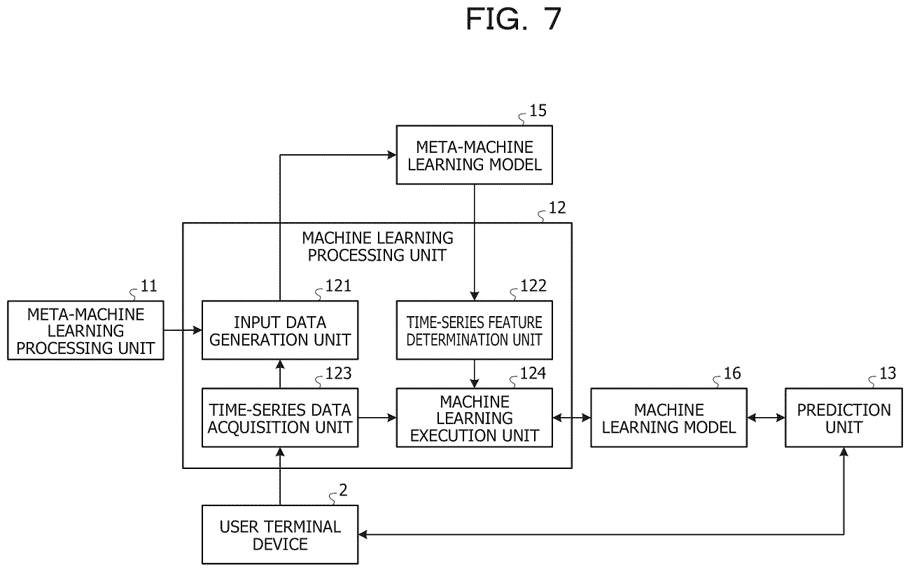

FIG. 7 is a block diagram of the machine learning processing unit. The machine learning processing unit 12 includes an input data generation unit 121, a time-series feature determination unit 122, a time-series data acquisition unit 123, and a machine learning execution unit 124.

The time-series data acquisition unit 123 receives time-series data that is new training data to be used by a user from the user terminal device 2. Then, the time-series data acquisition unit 123 outputs the acquired new time-series data to the input data generation unit 121 and the machine learning execution unit 124.

The input data generation unit 121 receives an input of the new time-series data from the time-series data acquisition unit 123. In addition, the input data generation unit 121 acquires information on the combinations of elements from the meta-machine learning processing unit 11. Then, the input data generation unit 121 performs Fourier transform on the new time-series data and extracts a predetermined number of periods from the top among the periods having stronger frequency components. Next, the input data generation unit 121 calculates information indicating closeness between a constant multiple of the period of data and the time width for each combination of elements, as a meta feature of the time-series feature for each combination of elements, using the extracted periods. Thereafter, the input data generation unit 121 inputs the meta features of the time-series features for each combination of elements to the trained meta-machine learning model 15.

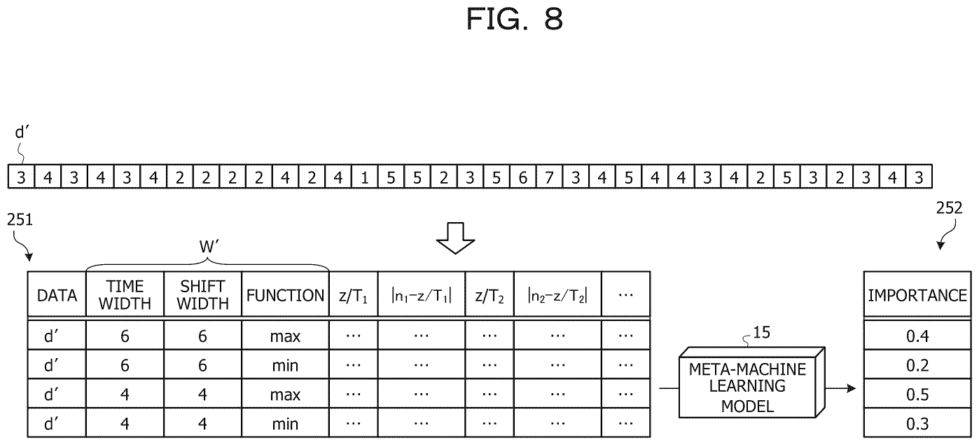

FIG. 8 is a diagram illustrating calculation of the importance of a combination of elements according to the first embodiment. For example, the time-series data acquisition unit 123 acquires new time-series data d′. Next, the input data generation unit 121 acquires information on combinations of the elements indicated by a column group W′ from the meta-machine learning processing unit 11. Next, the input data generation unit 121 calculates the meta features of the time-series features for each combination of elements in the new time-series data d′ and obtains the information illustrated in a table 251. Thereafter, the meta-machine learning model 15 receives an input of the information illustrated in the table 251 from the input data generation unit 121 and outputs importance 252 of each combination of elements in the new time-series data d′.

Returning to FIG. 7, the description will be continued. The time-series feature determination unit 122 acquires the importance of each combination of elements in the new time-series data output from the meta-machine learning model 15. Then, the time-series feature determination unit 122 determines a combination of elements having higher importance as a combination of elements to be used for training using the new time-series data. For example, the time-series feature determination unit 122 extracts a predetermined number of combinations of elements in order from the highest importance. Besides, the time-series feature determination unit 122 may extract a combination of elements with importance higher than a predetermined threshold value. Thereafter, the time-series feature determination unit 122 outputs information on the determined combinations of elements to be used for training using the new time-series data to the machine learning execution unit 124.

The machine learning execution unit 124 receives an input of the new time-series data from the time-series data acquisition unit 123. The machine learning execution unit 124 also receives an input of information on the combinations of elements to be used for training using the new time-series data from the time-series feature determination unit 122.

Next, the machine learning execution unit 124 calculates time-series features in the new time-series data for each combination of elements to be used for training using the new time-series data. Then, the machine learning execution unit 124 executes training of the machine learning model 16, using the new time-series data and the time-series features. This generates the trained machine learning model 16.

The prediction unit 13 receives prediction target time-series data from the user terminal device 2. Then, the prediction unit 13 acquires a prediction result output by inputting the prediction target time-series data to the trained machine learning model 16. Then, the prediction unit 13 transmits the prediction result for the prediction target time-series data to the user terminal device 2.

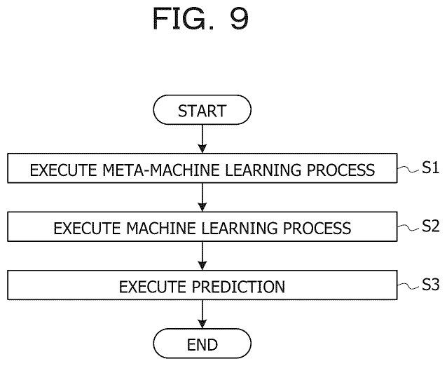

FIG. 9 is a flowchart illustrating an outline of a prediction process for time-series data using machine learning by the information processing device according to the first embodiment. Next, an outline of the prediction process for time-series data using machine learning by the information processing device 1 according to the first embodiment will be described with reference to FIG. 9.

The meta-machine learning processing unit 11 evaluates the prediction results with respect to the combinations of elements of the time-series feature in the time-series data, using the prediction performance evaluation model 14, and finds the importance of each combination of elements of the time-series feature. Then, the meta-machine learning processing unit 11 executes a meta-machine learning process of training the meta-machine learning model 15 using the combinations of elements of the time-series feature, the meta features, and the importance of the combinations of elements of the time-series feature (step S1).

The machine learning processing unit 12 acquires time-series data to be used for training of the machine learning model 16 to determine a combination of elements of the time-series feature suitable for training of the acquired time-series data. Then, the machine learning processing unit 12 executes a machine learning process of training the machine learning model 16 using the time-series features obtained from the determined combination of elements (step S2).

The prediction unit 13 receives time-series data to be used for prediction from the user terminal device 2. Then, the prediction unit 13 acquires a prediction result output by inputting the time-series data to be used for prediction to the trained machine learning model 16. This ensures that the prediction unit 13 executes prediction for the time-series data received from the user terminal device 2 (step S3).

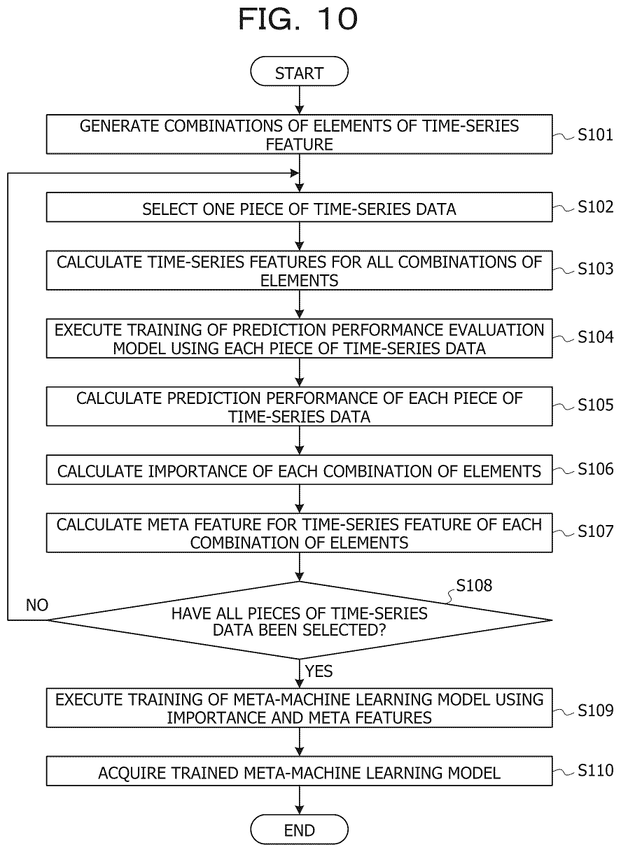

FIG. 10 is a flowchart of the meta-machine learning process by the information processing device according to the first embodiment. Next, a flow of the meta-machine learning process by the information processing device 1 according to the first embodiment will be described with reference to FIG. 10. The process illustrated in FIG. 10 corresponds to an example of the process executed in step S1 in the flow illustrated in FIG. 9.

The feature element generation unit 112 checks the time-series data stored in the time-series data storage unit 111 to determine, according to the time-series data, the time width, the shift width, the number of pieces of data, and the function, which are the elements of the time-series feature, and generates a plurality of combinations of elements of the time-series feature (step S101).

The time-series feature calculation unit 113 selects one piece of the time-series data from a set of time-series data stored in the time-series data storage unit 111 (step S102).

Next, the time-series feature calculation unit 113 acquires a combination of elements from the feature element generation unit 112. Then, the time-series feature calculation unit 113 calculates time-series features for all combinations of elements for the selected time-series data (step S103).

The training execution unit 114 acquires the time-series features of the selected time-series data for each combination of elements from the time-series feature calculation unit 113. Then, the training execution unit 114 executes training of the prediction performance evaluation model 14 using the acquired time-series features (step S104).

The prediction performance calculation unit 115 acquires the time-series data selected by the time-series feature calculation unit 113 from the time-series data storage unit 111. Then, the prediction performance calculation unit 115 generates time-series features for each combination of elements of the time-series features from the time-series data and inputs the generated time-series features to the trained prediction performance evaluation model 14 to obtain a prediction result. Thereafter, the prediction performance calculation unit 115 calculates the prediction performance of the prediction performance evaluation model 14 for the selected time-series data, using the acquired prediction results (step S105).

The importance calculation unit 116 receives inputs of the time-series features, the prediction results, and the prediction performance for each combination of elements for the selected time-series data, from the prediction performance calculation unit 115. Next, the importance calculation unit 116 calculates the importance of each combination of elements for the selected time-series data, using permutation importance (step S106).

The meta feature calculation unit 117 acquires the time-series data selected by the time-series feature calculation unit 113 from the time-series data storage unit 111. In addition, the meta feature calculation unit 117 receives information on the combinations of elements from the feature element generation unit 112. Next, the meta feature calculation unit 117 performs Fourier transform on the selected time-series data. Then, the meta feature calculation unit 117 calculates information indicating closeness between a constant multiple of the period of data and the time width, as a meta feature of the time-series feature for each combination of elements, based on the extracted frequency (step S107).

Next, the time-series feature calculation unit 113 verifies whether or not the calculation of the meta feature has been executed for all pieces of the time-series data included in the set of time-series data stored in the time-series data storage unit 111 (step S108). When there is time-series data for which the meta feature has not been calculated (step S108: negative), the time-series feature calculation unit 113 returns to step S102.

On the other hand, when the calculation of the meta feature has been executed for all pieces of the time-series data (step S108: affirmative), the meta-machine learning execution unit 118 acquires the importance of each combination of elements from the importance calculation unit 116. In addition, the meta-machine learning execution unit 118 receives inputs of the meta features of the time-series features for each combination wj of elements from the meta feature calculation unit 117. Then, the meta-machine learning execution unit 118 executes training of the meta-machine learning model 15, using the meta features of the time-series features for each combination of elements, with the importance of each combination of elements as a regression problem (step S109).

This ensures that the information processing device 1 acquires the trained meta-machine learning model 15 (step S110).

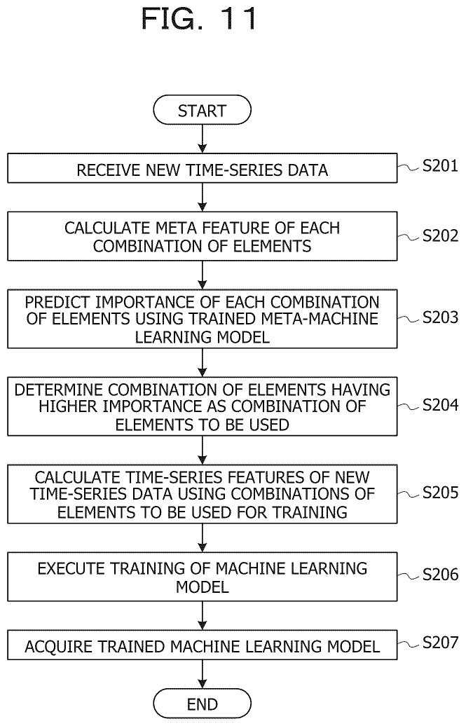

FIG. 11 is a flowchart of the machine learning process by the information processing device according to the first embodiment. Next, a flow of the machine learning process by the information processing device 1 according to the first embodiment will be described with reference to FIG. 11. The process illustrated in FIG. 11 corresponds to an example of the process executed in step S2 in the flow illustrated in FIG. 9.

The time-series data acquisition unit 123 receives time-series data that is new training data to be used by a user from the user terminal device 2 (step S201). Then, the time-series data acquisition unit 123 outputs the acquired new time-series data to the input data generation unit 121 and the machine learning execution unit 124.

The input data generation unit 121 acquires the new time-series data from the time-series data acquisition unit 123. In addition, the input data generation unit 121 acquires information on the combinations of elements from the meta-machine learning processing unit 11. Then, the input data generation unit 121 performs Fourier transform on the new time-series data and extracts a predetermined number of periods from the top among the periods having stronger frequency components. Next, the input data generation unit 121 calculates the time width of each combination of elements as a meta feature of the time-series feature for each combination of elements, using the extracted periods (step S202).

The input data generation unit 121 inputs the meta features of the time-series features for each combination of elements to the trained meta-machine learning model 15. The time-series feature determination unit 122 acquires the importance of each combination of elements output from the meta-machine learning model 15 (step S203).

Next, the time-series feature determination unit 122 determines a combination of elements having higher importance as a combination of elements to be used for training using the new time-series data (step S204).

The machine learning execution unit 124 receives an input of new time-series data from the time-series data acquisition unit 123. The machine learning execution unit 124 also receives an input of information on the combinations of elements to be used for training using the new time-series data from the time-series feature determination unit 122. Next, the machine learning execution unit 124 calculates time-series features in the new time-series data for each combination of elements to be used for training using the new time-series data (step S205).

Then, the machine learning execution unit 124 executes training of the machine learning model 16, using the new time-series data and the time-series features (step S206).

This ensures that the information processing device 1 acquires the trained machine learning model 16 (step S207).

As described above, the information processing device according to the first embodiment evaluates the prediction performance using permutation importance and finds the importance of each combination of elements. In addition, the information processing device performs Fourier transform on the time-series data to identify a period having a stronger frequency component and generates the meta feature of the time-series feature for each combination of elements, using the identified period having the stronger frequency component. Then, the information processing device executes training of the meta-machine learning model that predicts the importance of each combination of elements from the meta feature of the time-series feature for each combination of elements of the time-series feature, using the generated meta feature.

This may enable to automatically determine the combination of elements of the time-series feature of the time-series data. In one example, the time width, which is one of the important elements of the time-series feature of the time-series data, may be automatically determined. Therefore, the time taken for the analysis when the analysis of the time-series data is automated may be shortened, and the storage capacity for storing the data may be kept lower. Accordingly, the efficiency of machine learning using the time-series data may be improved.

### Second Embodiment

Next, a second embodiment will be described. The information processing device 1 illustrated in the block diagram in FIG. 1 also applies to the second embodiment. The information processing device 1 according to the second embodiment is different from the information processing device 1 of the first embodiment in that the combination of elements of the time-series feature used for training is determined using the importance of the time width among the elements of the time-series feature. In the following description, description of the operation of each unit similar to the units of the first embodiment will be sometimes omitted. In addition, in the following description, a set of time widths is assumed as Z, and each time width included in Z is assumed as zj.

The meta-machine learning processing unit 11 illustrated in the block diagram in FIG. 3 also applies to the second embodiment. An operation of the meta-machine learning processing unit 11 will be described.

The feature element generation unit 112 generates combinations of elements of time-series features similarly to the first embodiment. The time-series feature calculation unit 113 calculates all time-series features for each combination of elements generated by the feature element generation unit 112, similarly to the first embodiment. Similarly to the first embodiment, the training execution unit 114 executes training of the prediction performance evaluation model 14, using the time-series feature of each combination of elements. Similarly to the first embodiment, the prediction performance calculation unit 115 calculates the prediction performance of the trained prediction performance evaluation model 14 for each combination of elements, using the time-series data.

The importance calculation unit 116 receives inputs of the time-series features, the prediction results, and the prediction performance for each combination of elements for each piece of the time-series data, from the prediction performance calculation unit 115. Next, the importance calculation unit 116 calculates importance I_{di,zj} for each time width zj among the elements, using permutation importance for each piece of time-series data di. For example, for each time width zj, the importance calculation unit 116 performs prediction using the prediction performance evaluation model 14 by randomly substituting the time-series features for each other between the time-series data di and calculates the prediction performance in each case.

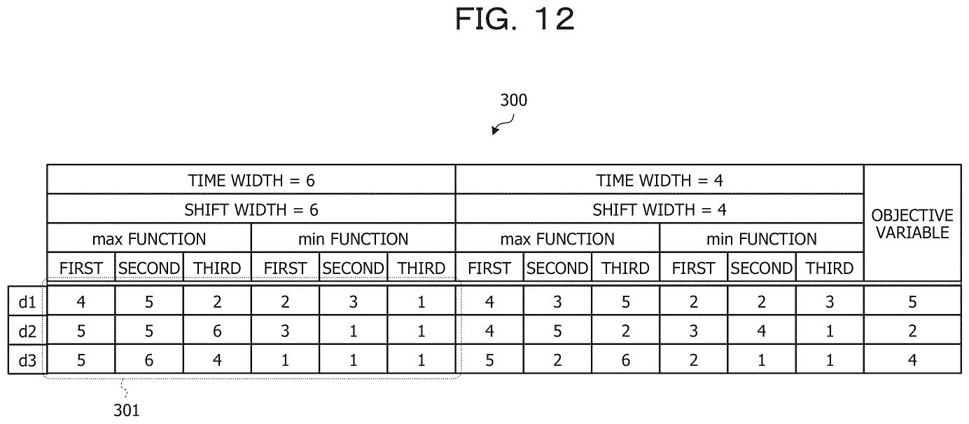

FIG. 12 is a diagram illustrating calculation of the importance of each time width. FIG. 12 illustrates, as an example, a case where there are four combinations of elements of “6, 6, 3, max function”, “6, 6, 3, min function”, “4, 4, 3, max function”, and “4, 4, 3, min function” for the time-series data d1 to d3. For example, the importance calculation unit 116 randomly substitutes, for each other, the time-series features in a group 301 in FIG. 12 where the time width of each piece of the time-series data d1 to d3 is six, for each column, and performs prediction using the prediction performance evaluation model 14. Similarly, also for a case where the time width is four, the importance calculation unit 116 performs prediction using the prediction performance evaluation model 14 by randomly substituting the time-series features for each other for each column between the time-series data d1 to d3. Then, the importance calculation unit 116 calculates the prediction performance for each piece of time-series data in each of a case where the time-series features when the time width is six are randomly substituted for each other and a case where the time-series features when the time width is four are randomly substituted for each other.

Next, the importance calculation unit 116 compares the prediction performance a_{di,0} of each piece of the time-series data di acquired from the prediction performance calculation unit 115 with the prediction performance when respective time-series features are randomly substituted for each other between time-series data for each time width zj. Then, the importance calculation unit 116 calculates the importance I_{di,zj} of each time width zj in each piece of the time-series data di. Thereafter, the importance calculation unit 116 outputs information on the calculated importance I_{di,zj} of each time width zj in each piece of the time-series data di to the meta-machine learning execution unit 118.

Here, in the second embodiment, the importance has been found by collectively substituting the whole time-series features included in each time width for each other, but the way of finding the importance is not limited to this. For example, the importance calculation unit 116 may find the importance by substituting every one of the time-series features included in each time width for another and assign a maximum value or a mean value of the found importance, as the importance of the time width.

The meta feature calculation unit 117 acquires each piece of the time-series data di from the time-series data storage unit 111. In addition, the meta feature calculation unit 117 receives information on the time width zj from the feature element generation unit 112.

Next, the meta feature calculation unit 117 performs Fourier transform on each piece of the time-series data di. Then, the meta feature calculation unit 117 extracts a predetermined number of periods from the top among the periods having stronger frequency components for each piece of the time-series data di.

Next, the meta feature calculation unit 117 calculates, for each piece of the time-series data di, a meta feature f_{di,zj} of the time-series feature for each time width zj, based on the extracted frequency. In the second embodiment, the meta feature calculation unit 117 calculates information indicating closeness between a constant multiple of the period and the time width, as the meta feature f_{di,zj} of the time-series feature for each time width zj. For example, the meta feature calculation unit 117 assigns, as the meta features f_{di,zj} of the time-series feature for the time width zj, an integer closest to a value obtained by dividing the time width zj by each of a predetermined number of periods having stronger frequency components from the top when the Fourier transform is performed on the time-series data di, and a difference between those integer and quotient. Then, the meta feature calculation unit 117 outputs the calculated meta features f_{di,zj} of the time-series features for the time widths zj for each piece of the time-series data di to the meta-machine learning execution unit 118.

The meta-machine learning execution unit 118 receives inputs of the importance I_{di,zj} of each time width zj for each piece of the time-series data di from the importance calculation unit 116. The meta-machine learning execution unit 118 also receives inputs of the meta features f_{di,zj} of the time-series features for each time width zj for each piece of the time-series data di from the meta feature calculation unit 117.

Then, the meta-machine learning execution unit 118 executes training of the meta-machine learning model 15, using the meta features f_{di,zj} of the time-series features for each time width zj, with the importance I_{di,zj} of each time width zj in each of the time-series data di as a regression problem. This generates the trained meta-machine learning model 15.

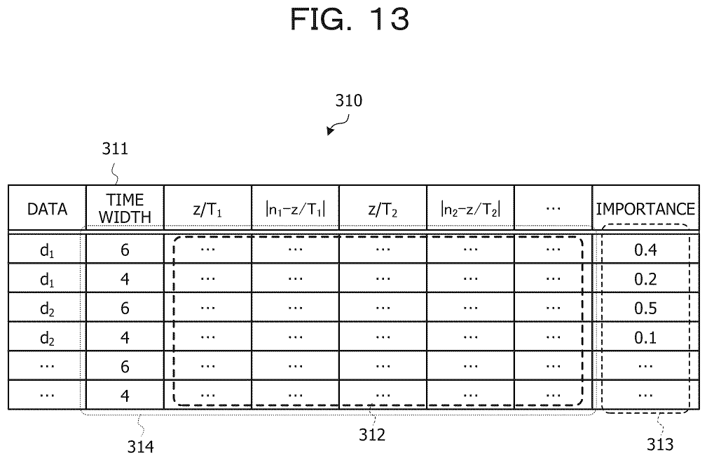

FIG. 13 is a diagram illustrating meta-machine learning according to the second embodiment. Here, there are time-series data d1, d2, . . . . Then, a column 311 in a table 310 indicates time widths separately in each piece of the time-series data d1, d2, . . . . Furthermore, the portion surrounded by a frame 312 indicates the meta features for each time width. The portion surrounded by a frame 313 indicates the importance of each combination of elements. The meta-machine learning execution unit 118 executes training of the meta-machine learning model 15 with data of the portion surrounded by a frame 314 as meta-training data.

The machine learning processing unit 12 illustrated in the block diagram in FIG. 7 also applies to the second embodiment. Next, an operation of the machine learning processing unit 12 will be described.

The input data generation unit 121 receives an input of new time-series data from the time-series data acquisition unit 123. In addition, the input data generation unit 121 acquires information on the combinations of elements from the meta-machine learning processing unit 11. Then, the input data generation unit 121 performs Fourier transform on the new time-series data and extracts a predetermined number of periods from the top among the periods having stronger frequency components. Next, the input data generation unit 121 calculates information indicating closeness between a constant multiple of the period of the data and the time width, as a meta feature of the time-series feature for each time width among the elements of the time-series feature, using the extracted periods. Thereafter, the input data generation unit 121 inputs the meta features of the time-series features for each time width to the trained meta-machine learning model 15.

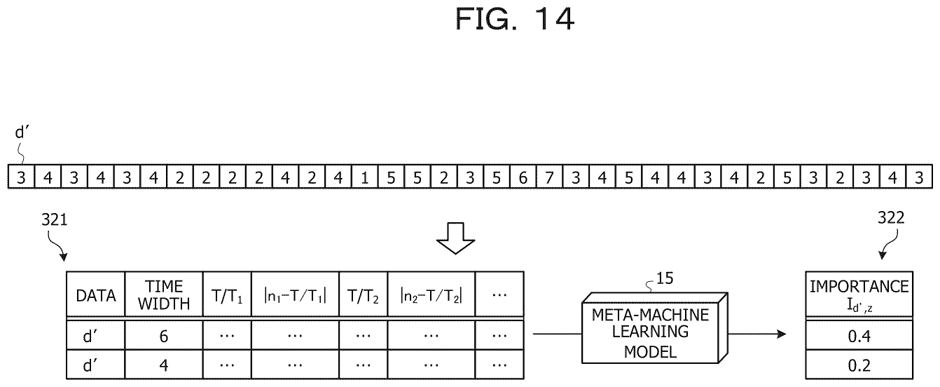

FIG. 14 is a diagram illustrating calculation of the importance of a combination of elements according to the second embodiment. For example, the input data generation unit 121 calculates the meta features of the time-series features for each time width for the new time-series data d′ and obtains the information illustrated in a table 321. Thereafter, the meta-machine learning model 15 receives an input of the information illustrated in the table 321 from the input data generation unit 121 and outputs importance 322 of each time width in the new time-series data d′.

The time-series feature determination unit 122 acquires the importance of each time width output from the meta-machine learning model 15. Then, the time-series feature determination unit 122 determines time widths having higher importance as a combination of elements to be used for training using the new time-series data. For example, the time-series feature determination unit 122 extracts a predetermined number of time widths in order from the highest importance. Besides, the time-series feature determination unit 122 may extract time widths with importance higher than a predetermined threshold value. Thereafter, the time-series feature determination unit 122 outputs information on the determined time widths to be used for training using the new time-series data to the machine learning execution unit 124.

The machine learning execution unit 124 receives an input of the new time-series data from the time-series data acquisition unit 123. The machine learning execution unit 124 also receives an input of information on the time widths to be used for training using the new time-series data from the time-series feature determination unit 122.

Next, the machine learning execution unit 124 calculates time-series features in the new time-series data for each combination of elements that includes the time widths and is to be used for training using the new time-series data. Then, the machine learning execution unit 124 executes training of the machine learning model 16, using the new time-series data and the time-series features. This generates the trained machine learning model 16.

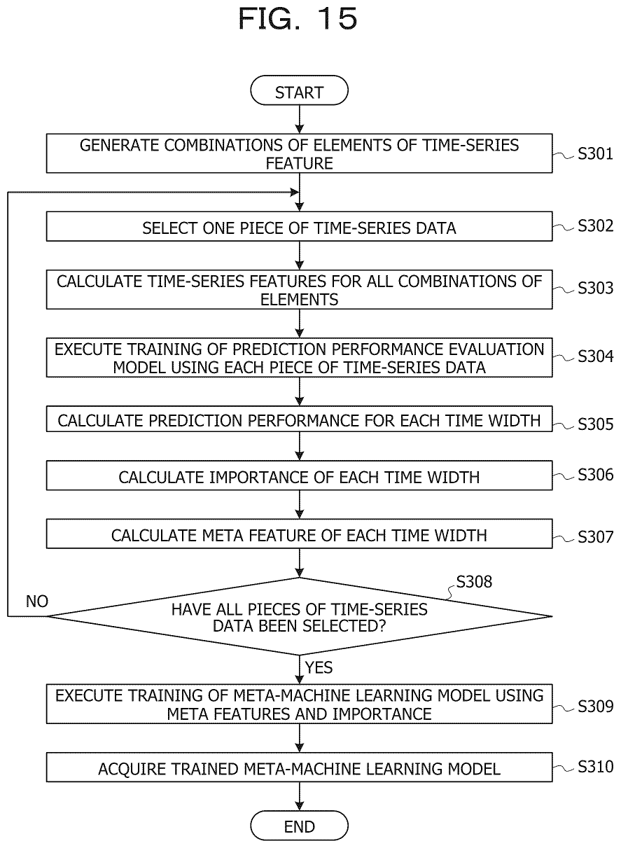

FIG. 15 is a flowchart of a meta-machine learning process by the information processing device according to the second embodiment. Next, a flow of the meta-machine learning process by the information processing device 1 according to the second embodiment will be described with reference to FIG. 15.

The feature element generation unit 112 checks the time-series data stored in the time-series data storage unit 111 to determine the time width, the shift width, the number of pieces of data, and the function, which are the elements of the time-series feature, according to the time-series data, and generates a plurality of combinations of elements of the time-series feature (step S301).

The time-series feature calculation unit 113 selects one piece of the time-series data from a set of time-series data stored in the time-series data storage unit 111 (step S302).

The time-series feature calculation unit 113 acquires a combination of elements from the feature element generation unit 112. Next, the time-series feature calculation unit 113 acquires the set of time-series data from the time-series data storage unit 111. Then, the time-series feature calculation unit 113 calculates time-series features for all time widths among the elements for each piece of time-series data (step S303).

The training execution unit 114 acquires the time-series features of the selected time-series data for each time width from the time-series feature calculation unit 113. Then, the training execution unit 114 executes training of the prediction performance evaluation model 14 using the acquired time-series features (step S304).

The prediction performance calculation unit 115 acquires the time-series data selected by the time-series feature calculation unit 113 from the time-series data storage unit 111. Then, the prediction performance calculation unit 115 generates time-series features for each time width in the combinations of elements for the selected time-series data and inputs the generated time-series features to the trained prediction performance evaluation model 14 to obtain a prediction result. Thereafter, the prediction performance calculation unit 115 calculates the prediction performance of the prediction performance evaluation model 14 for the selected time-series data, using the acquired prediction results (step S305).

The importance calculation unit 116 receives inputs of the time-series features, the prediction results, and the prediction performance for each time width for the selected time-series data, from the prediction performance calculation unit 115. Next, the importance calculation unit 116 calculates the importance of each time width, using permutation importance (step S306).

The meta feature calculation unit 117 acquires the time-series data selected by the time-series feature calculation unit 113 from the time-series data storage unit 111. In addition, the meta feature calculation unit 117 receives information on the combinations of elements from the feature element generation unit 112. Next, the meta feature calculation unit 117 performs Fourier transform on the selected time-series data. Then, the meta feature calculation unit 117 calculates information indicating closeness between a constant multiple of the period of data and the time width, as a meta feature of the time-series feature for each time width among the elements, based on the extracted frequency (step S307).

Next, the time-series feature calculation unit 113 verifies whether or not the calculation of the meta feature has been executed for all pieces of the time-series data included in the set of time-series data stored in the time-series data storage unit 111 (step S308). When there is time-series data for which the meta feature has not been calculated (step S308: negative), the time-series feature calculation unit 113 returns to step S302.

On the other hand, when the calculation of the meta feature has been executed for all pieces of the time-series data (step S308: affirmative), the meta-machine learning execution unit 118 acquires the importance of each time width from the importance calculation unit 116. In addition, the meta-machine learning execution unit 118 receives inputs of the meta features of the time-series features for each time width from the meta feature calculation unit 117. Then, the meta-machine learning execution unit 118 executes training of the meta-machine learning model 15, using the meta features of the time-series features for each time width, with the importance of each time width as a regression problem (step S309).

This ensures that the information processing device 1 acquires the trained meta-machine learning model 15 (step S310).

As described above, the information processing device 1 according to the second embodiment executes training of the meta-machine learning model that outputs the importance of the time width with the meta feature of the time-series feature for the time width as an input. Then, the information processing device 1 determines a time width to be used for training using the new time-series data, by using the trained meta-machine learning model, and executes training of the machine learning model using the time-series features of the combination of elements including the determined time width.

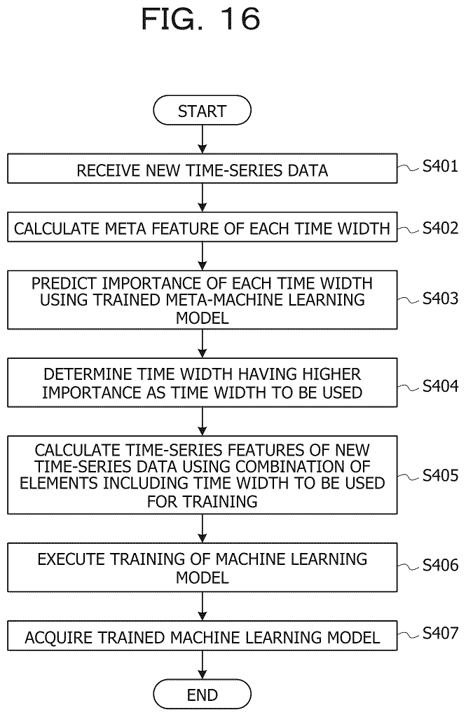

FIG. 16 is a flowchart of a machine learning process by the information processing device 1 according to the second embodiment. While description of each step is omitted, steps S401 to S407 in FIG. 16 correspond to steps S201 to S207 in FIG. 11, respectively.

This may enable to automatically determine the time width, which is one of the important elements of the time-series feature of the time-series data. Therefore, the time taken for the analysis when the analysis of the time-series data is automated may be shortened, and the storage capacity for storing the data may be kept lower. Accordingly, the efficiency of machine learning using the time-series data may be improved.

In addition, in the second embodiment, the time width is selected as a characteristic element of the time-series feature, and the time-series feature is selected using the importance of the time width. However, also for the shift width or the like, the information processing device 1 may calculate the importance of the shift width by executing training of the meta-machine learning model 15 with a value indicating the relationship with the periods as a meta feature and may also select the time-series feature using the calculated value.

(First Modification)

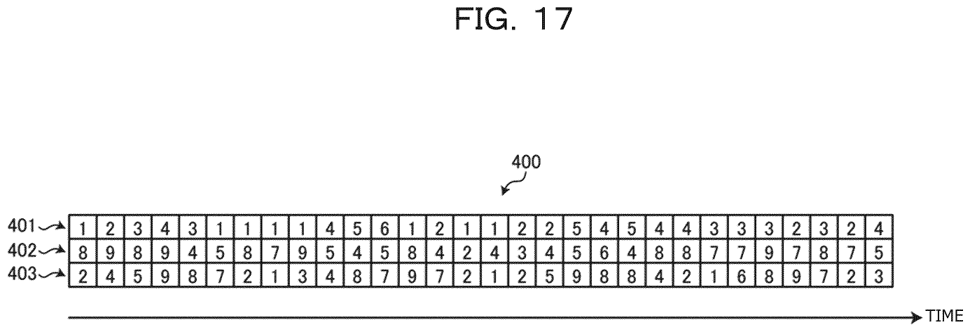

FIG. 17 is a diagram illustrating an example of time-series data in a first modification. The information processing device 1 according to the first of data 401 to 403 as illustrated in FIG. 17. The time-series data 400 is, for example, information obtained by a speed sensor having an x-axis, a y-axis, and a z-axis, where the data 401 is speed information on the x-axis, the data 402 is speed information on the y-axis, and the data 403 is speed information on the z-axis.

Each of the meta-machine learning processing unit 11, the machine learning processing unit 12, and the prediction unit 13 regards the data 401 to 403 of the time-series data 400 for each series as time-series data of different types from each other and sets a task for each series to execute training and prediction.

This may allow the information processing device 1 according to the first modification to also process time-series data including a plurality of different series of data as in the case of time-series data including one series and to perform prediction by setting an appropriate time-series feature. Accordingly, the efficiency of machine learning using time-series data may be improved even for time-series data including a plurality of different series of data.

(Second Modification)

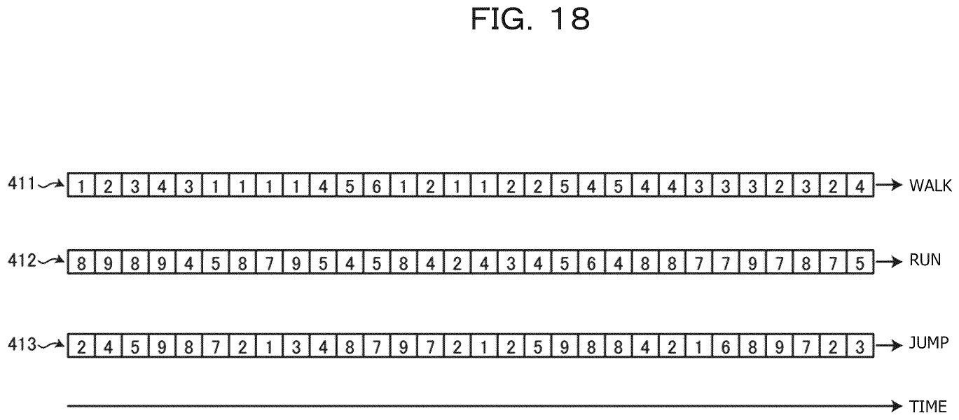

FIG. 18 is a diagram illustrating an example of time-series data in a second modification. The information processing device 1 according to the second modification handles time-series data 411 to 413 in which objective variables (labels) are set in advance in each piece of data as illustrated in FIG. 18. For example, the time-series data 411 to 413 are data obtained by a sensor that detects movement of a person for 60 seconds. Then, a label “walk” is given to the time-series data 411, a label “run” is given to the time-series data 412, and a label “jump” is given to the time-series data 413.

Each of the meta-machine learning processing unit 11, the machine learning processing unit 12, and the prediction unit 13 execute training and prediction by concatenating the time-series data 411 to 413 as they are and treating the concatenated time-series data 411 to 413 as one string of time-series data.

This may allow the information processing device according to the second modification to perform processing as in the case of each embodiment even when the time-series data is set with an objective variable in advance and to perform prediction by setting an appropriate time-series feature. Accordingly, the efficiency of machine learning using time-series data may be improved even for time-series data set with an objective variable in advance.

(Hardware Configuration)

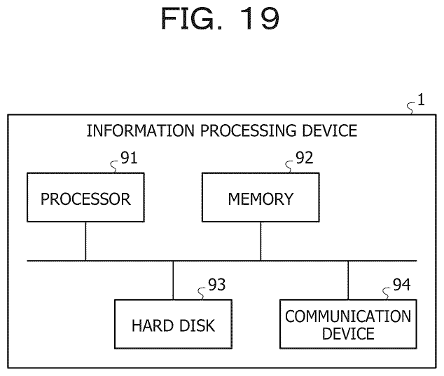

FIG. 19 is a hardware configuration diagram of the information processing device. The information processing device 1 described in each of the above embodiments and modifications may be implemented by a hardware configuration as in FIG. 19. For example, the information processing device 1 includes a processor 91, a memory 92, a hard disk 93, and a communication device 94. The processor 91 is coupled to the memory 92, the hard disk 93, and the communication device 94 via a bus.

The communication device 94 is an interface for communication between the information processing device 1 and an external device. The communication device 94 relays communication between the processor 91 and the user terminal device 2, for example.

The hard disk 93 is an auxiliary storage device. The hard disk 93 stores the prediction performance evaluation model 14, the meta-machine learning model 15, and the machine learning model 16 exemplified in FIG. 1. The hard disk 93 also stores various programs including a program for implementing the functions of the meta-machine learning processing unit 11, the machine learning processing unit 12, and the prediction unit 13 exemplified in FIG. 1.

The memory 92 is a main storage device. The memory 92 is, for example, a dynamic random access memory (DRAM).

The processor 91 reads various programs stored in the hard disk 93 and loads the read programs into the memory 92 to execute the loaded programs. This ensures that the processor 91 implements the functions of the meta-machine learning processing unit 11, the machine learning processing unit 12, and the prediction unit 13 exemplified in FIG. 1.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a program for causing a computer to execute a process, the process comprising:
identifying frequency components stronger than a predetermined reference among frequency components of time-series data;
calculating values that indicate a relationship between one or more parameters used when generating a plurality of time-series features of the time-series data and periods having the identified frequency components, as features for the parameters;
executing training of a first machine learning model by using importance of each of the time-series features on prediction that uses the time-series features and the features for each of the parameters to predict the importance of the time-series features from the features for each of the parameters, the time-series features being generated based on the parameters; and
predicting importance of time-series features for new time-series data by using the trained first machine learning model.

2. The non-transitory computer-readable recording medium according to claim 1, the process further comprising:
calculating the values based on results of dividing constant multiples of the periods by time widths among the parameters.

3. The non-transitory computer-readable recording medium according to claim 1, the process further comprising:
calculating features for the parameters for the new time-series data; and
inputting the calculated features for the parameters to the trained first machine learning model to predict importance of the time-series features for the new time-series data.

4. The non-transitory computer-readable recording medium according to claim 1, the process further comprising:
determining specific time-series features to be used for training of a second machine learning model that performs prediction with time-series features as input data, based on the predicted importance of the time-series features for the new time-series data; and
executing the training of the second machine learning model by using the specific time-series features for the time-series data.

5. The non-transitory computer-readable recording medium according to claim 1, the process further comprising:
calculating features for each of time widths included in the parameters as the features for the parameters;
calculating importance of each of the time widths as the importance of each of the time-series features; and
executing the training of the first machine learning model by using the importance of each of the time widths and the features for each of the time widths.

6. An information processing method, comprising:
identifying, by a computer, frequency components stronger than a predetermined reference among frequency components of time-series data;
calculating values that indicate a relationship between one or more parameters used when generating a plurality of time-series features of the time-series data and periods having the identified frequency components, as features for the parameters;
executing training of a first machine learning model by using importance of each of the time-series features on prediction that uses the time-series features and the features for each of the parameters to predict the importance of the time-series features from the features for each of the parameters, the time-series features being generated based on the parameters; and
predicting importance of time-series features for new time-series data by using the trained first machine learning model.

7. An information processing device, comprising:
a memory; and
a processor coupled to the memory and the processor configured to:
identify frequency components stronger than a predetermined reference among frequency components of time-series data;
calculate values that indicate a relationship between one or more parameters used when generating a plurality of time-series features of the time-series data and periods having the identified frequency components, as features for the parameters;
execute training of a first machine learning model by using importance of each of the time-series features on prediction that uses the time-series features and the features for each of the parameters to predict the importance of the time-series features from the features for each of the parameters, the time-series features being generated based on the parameters; and
predict importance of time-series features for new time-series data by using the trained first machine learning model.
